(19) United States
(12) Patent Application Publication
(10) Pub. No.: US 2013/0297345 A1
(43) Pub. Date: Nov. 7, 2013

(54) Electronic Medical Record Hosting System and Method

(71) Applicant: Medical Records Systems, Scottsdale, AZ (US)

(72) Inventors: C. Arnold Curry, Scottsdale, AZ (US); Michael P. Glass, Denver, CO (US)

(73) Assignee: Medical Records Systems, Scottsdale, AZ (US)

(21) Appl. No.: 13/886,769

(22) Filed: May 3, 2013

Related U.S. Application Data
(60) Provisional application No. 61/641,982, filed on May 3, 2012.

(51) Int. Cl. G06F 19/00

(52) U.S. Cl. CPC G06F 19/322
USPC 705/3

(57) ABSTRACT

A method is disclosed. The method includes the steps of: arranging an electronic medical record hosting system including a provider end and one or more of a subscriber end and an authorized person end; providing medical information from one or more of the subscriber end and the authorized person end to the provider end; electronically storing the provided medical information at the provider end; and utilizing a computer workstation at any of the provider end, the subscriber end and the authorized person end for permitting any of the provider end, the subscriber end and the authorized person end to securely electronically view and/or securely electronically modify the medical information that is electronically stored at the provider end. A medical record system is also disclosed. A computer program product is also disclosed.

### CROSS-REFERENCE TO RELATED APPLICATIONS

This U.S. patent application claims priority to U.S. Provisional Application Ser. No. 61/641,982 filed on May 3, 2012, the disclosure of which is considered part of the disclosure of this application and is hereby incorporated by reference in its entirety.

### TECHNICAL FIELD

This disclosure relates to an electronic medical record hosting system and method.

### BACKGROUND

Medical records are typically retained for the purpose of documenting a person's health history. In some circumstances, access to the medical records may be inhibited due to, for example, physical distance between a requester of the medical record and a storage location of the medical record. Further, should a medical record be physically transported from the storage location to a requesting location, security of the medical record may be compromised. Accordingly, there is a need in the art for increasing access to medical records while maintaining security of the medical records.

### DESCRIPTION OF DRAWINGS

FIG. 1 is schematic view of an exemplary hosting system for providing interoperable, comprehensive electronic, private medical records.

FIG. 2 is a schematic view of an exemplary electronic data capture process for preparing an electronic, private medical record.

FIG. 3 is a schematic view of an exemplary electronic, private medical record security system.

FIG. 4A is a schematic view of an exemplary screenshot of an electronic, private medical record.

FIG. 4B is a schematic view of an exemplary screenshot of an electronic, private medical record.

FIG. 5 is a schematic view of an exemplary emergency medical card identifying a subscriber of an electronic, private medical record.

FIG. 6 is a schematic view of a method for obtaining access to an exemplary hosting system for providing interoperable, comprehensive electronic, private medical record medical records.

FIG. 7 is a schematic view of a wireframe of an exemplary website associated with an exemplary hosting system for providing interoperable, comprehensive electronic, private medical record medical records.

Like reference symbols in the various drawings indicate like elements.

### DETAILED DESCRIPTION

An electronic, private medical record hosting system may provide subscribers with electronic access to an organized, indexed-and-catalogued solution for establishing and permitting continued editing of at least one person's private medical record. All of the data contained in the electronic, private medical record may be encrypted digital data; additionally all of the data in the electronic, private medical record may be protected by way of a “double layer” of security (e.g., physical security and digital security). The electronic, private health care record may include one or more of: picture archiving and communication system (PACS) images, digital imaging and communication-in-medicine (DICOM) images, portable data file (PDF) images, moving picture experts group (MPEG) images, short message service (SMS) data types, manufacturing message specification (MMS) data types or the like. One or more documents from the private health care record may be retrieved by, for example, by conducting an investigation for an inclusion of a key-word or phrase within one or more of the documents.

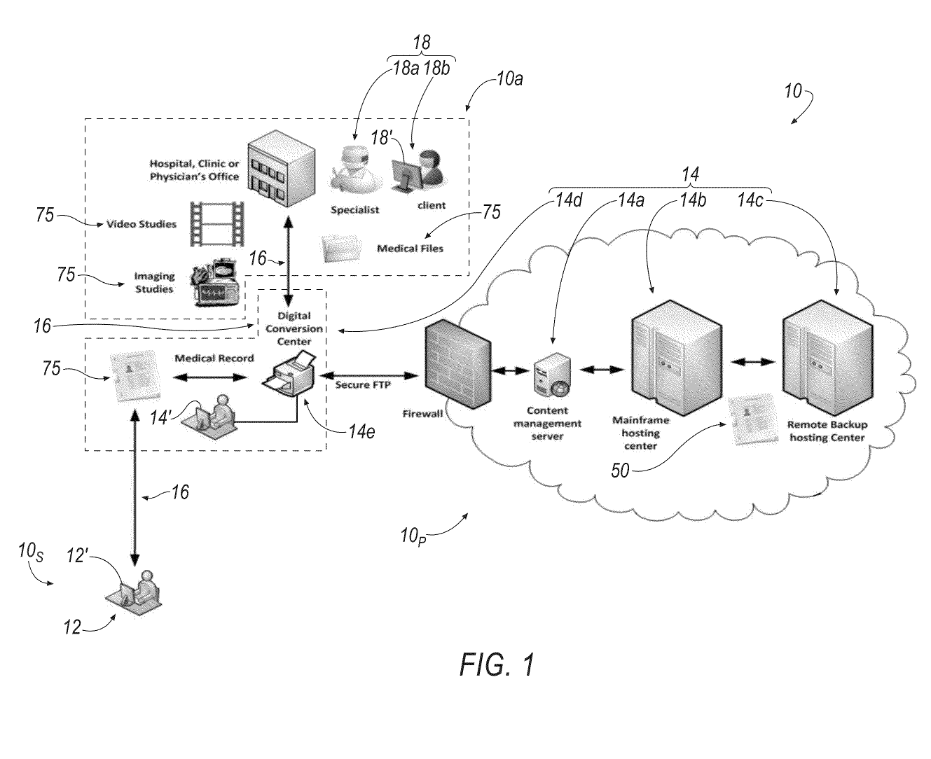

Referring to FIG. 1, in some implementations, a hosting system for providing interoperable, comprehensive electronic medical records 10 is shown. A subscriber to the hosting system 10 is shown generally at 12 at a subscriber end 10_{S} and a provider of the hosting system 10 is shown generally at 14 at a provider end 10_{P}.

Although the provider 14 is generally represented by an “Internet cloud”/“public cloud,” the provider 14 may additionally or alternatively include one or more of a content management server 14a, a mainframe hosting center 14b and a remote hosting backup center 14c. Accordingly, in an embodiment, the provider 14 may include at least one or more of a hardware component and a software component that communicates with the subscriber 12 by way of a communication conduit 16 (e.g., “snail mail,” telephone, an Internet connection, or the like).

“Cloud computing” associated with the provider 14 may provide Internet-based computing, whereby shared servers provide resources, software, and data to computers 12′, 14′, 18′ and other devices on demand. For example, the “cloud” may be a cloud computing service that includes at least one server computing device, which may include a service abstraction layer and a hypertext transfer protocol wrapper over a server virtual machine instantiated thereon. The server computing device may be configured to parse HTTP requests and send HTTP responses. Cloud computing may be a technology that uses the Internet and central remote servers to maintain data and applications. Cloud computing can allow users to access and use applications without installation and access personal files at any computer 12′, 14′, 18′ with internet access. Cloud computing allows for relatively more efficient computing by centralizing storage, memory, processing and bandwidth. The cloud can provide scalable, on-demand computing power, storage, and bandwidth. Safe connectivity to the cloud allows automatic data gathering of safe operation and usage histories without requiring a user of the hosting system 10 to enter and upload data. Moreover, continuous data collection over time can yield a wealth of data that can be mined for information (e.g., information that is related to or contained within the subscriber's electronic, private medical record). “Cloud storage” associated with the provider 14 may be a model of networked computer data storage where data is stored on multiple virtual servers, generally hosted by third parties. Thus, by providing communication between the subscriber 12, the provider 14 and one or more authorized persons 18 by way of the “cloud,” gathered information 75, 75′ can be securely sent/received/viewed by authorized at computer workstations 12′, 14′, 18′ at any of the subscriber end 10_{S}, the provider end 10_{P} and the one or more authorized persons end 10_{A} via, for example, a web based information portal.

Although a cloud network that utilizes the Internet is described in the above embodiment, the hosting system 10 may employ other communication techniques. For example, the hosting system 10 may employ a telemetry communication technique. Telemetry may include, for example, communication and reception of wired/wireless communication over a telephone network, a computer network, an optical link, radio waves, hypersonic systems, infrared systems and the like.

In other example, the provider 14 may include an entity 14d; the entity may include one or more of an individual, a business (e.g., a corporation) or a structure. In an example, the entity 14d may locally house one or more of a computer workstation 14′, the content management server 14a, a mainframe hosting center 14b and a remote hosting backup center 14c; alternatively one or more of the content management server 14a, a mainframe hosting center 14b and a remote hosting backup center 14c may be housed remotely (e.g., in the cloud) and away from the entity 14d.

The provider end 14 may accommodate creation and management of an electronic, private medical record 50 for the subscriber 12. The subscriber 12 may be, for example, an individual or a group (e.g., a group being defined to include two or more person having some form of relationship where privacy rights are honored and respected within the group); accordingly, in an implementation, the hosting system 10 may offer a subscriber 12 with the ability to select one or more “plans.” In an implementation, each plan may include sufficient encrypted storage in order to house, for example, three hundred pages of searchable medical records 50 for each subscriber 12. In an example, families or individuals who have larger medical records may buy additional redundant storage. While services provided under each plan may be substantially similar, an amount of storage per subscriber 12 may be increased; this permits a subscriber 12 with, for example, a large family to pay lower costs per subscriber 12 while getting additional storage.

In a first implementation, a plan may be designed for an “individual” subscriber 12. In another implementation, a plan may be designed for a “couple” subscriber 12 (e.g., a married coupled or a domestic partnership of, for example, two individuals). In yet another implementation, a plan may be designed for a “small family” subscriber 12 (e.g., a married couple and one or two children). In another implementation, a plan may be designed for a “large family” subscriber 12 (e.g., a married coupled and three or more children). In each of the above plans similar include secure access at any time (e.g., 24-hours-a-day, 7-days-a-week, 365-days-a-year). Differences between plans may include an amount of data storage and in cost-per-person (e.g., an individual plan subscriber may pay more on a proportional basis when compared to a large family plan subscriber). The subscriber 12 may pay for the service on a monthly or annual basis; discounts may be provided is the subscriber 12 subscribes to a multi-year plan.

In an implementation, the provider 14 may include hardware/software 14a-14c that functionally hosts a website that enables or more acts of: receiving data, sending data, saving data and modifying previously saved data comprising the electronic, private medical record 50. In an embodiment, the hardware/software 14a-14c may permit the received/sent and saved/modified data to populate the electronic, private medical record 50 associated with the plan that was selected by the subscriber 12. Accordingly, the subscriber 12 and/or one or more authorized persons 18 (e.g., a doctor, a specialist, a nurse, a data entry technician or persons associated with or employed by a hospital, medical clinic or the like) may utilize their respective computer workstation 12′, 18′ in order to access the electronic, private medical record 50 in order to conduct one or more of the acts of receiving, sending, saving or modifying data at any time such that the subscriber 12 and/or the one or more authorized persons 18 may contribute to the creation and/or collaborative editing of the electronic, private medical record 50.

Once the subscriber 12 has selected a plan, the subscriber 12 may select a method of payment. Once a payment method is selected, the provider 14 collects medical information 75 from one or more of the subscriber 12 and the one or more authorized persons 18 by way of, for example, the communication conduit 16; the provided medical information 75 may include personal records that have been retained by the subscriber 12, imaging studies retained by the one or more authorized persons at the hospital 18, video studies retained by the one or more authorized persons at the hospital 18, medical files retained by the one or more authorized persons at the hospital 18, or the like.

The subscriber 12 and the one or more authorized persons 18 may communicate (by way of, e.g., the communication conduit 16) the medical information 75 to the provider 14 in any desirable fashion such as, for example: (1) mailing hardcopies of medical documents 75, (2) faxing hardcopies of medical records 75 from a FAX machine, (3) scanning a hardcopy medical document 75 and emailing an electronic copy of the hardcopy medical document 75, and/or (4) verbally informing the provider 14 of medical history over a telephone such that a data entry person at the provider end 10_{P} may utilize a provider end computer workstation 14′ for directly entering the orally provided medical information at the provider end 10_{P}.

In another example, the provider 14 may provide the subscriber 12 with, for example, a form letter questionnaire that the subscriber 12 may complete and subsequently return via mail, fax or email to the provider 14. In an implementation, one or more of the subscriber(s) 12 and the provider 14 may inform or provide the one or more authorized persons 18 with permission (e.g., a permission document) for authorizing the one or more authorized persons 18 to communicate with the provider 14 such that the provider 14 may request or solicit medical information 75 from the one or more authorized persons 18, and, so that the one or more authorized persons 18 is authorized to send the solicited or unsolicited medical information to the provider 14.

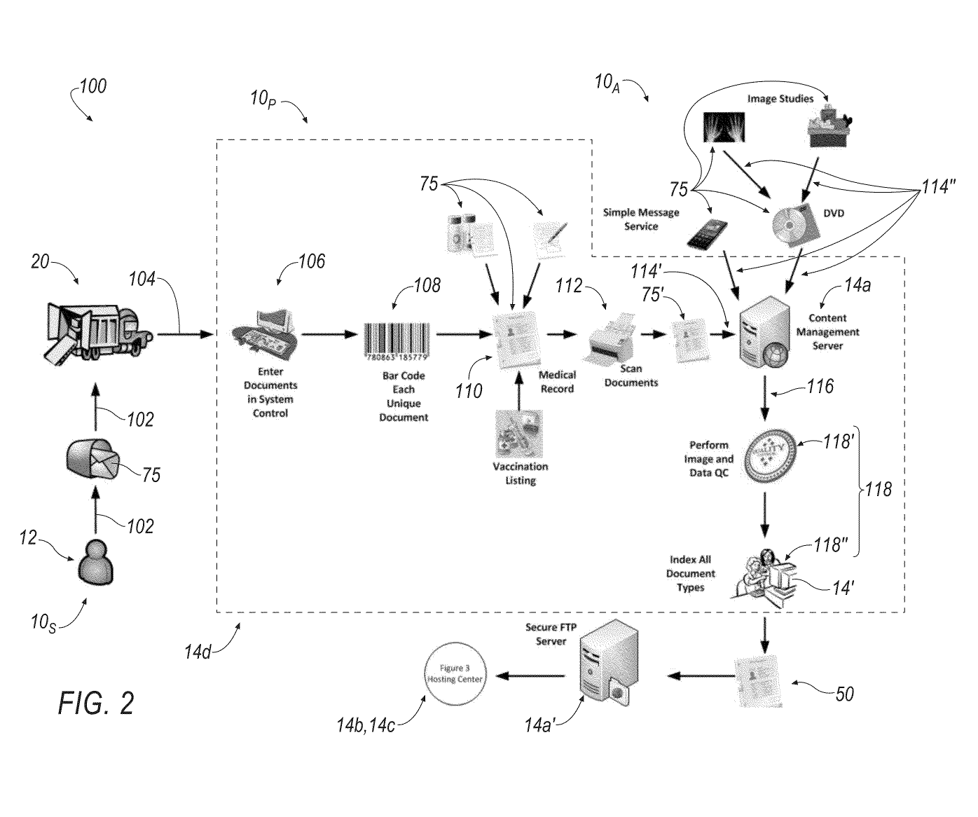

If hardcopy medical documents 75 are received by the provider 14, the entity 14d may include one or more electronic imaging devices 14e (e.g., one or more scanners). In an embodiment, the one or more electronic imaging devices 14e may be connected to the provider end computer workstation 14′. The one or more electronic imaging devices 14e may scan the hardcopy medical documents 75 in order to create electronic copies 75′ (see, e.g., FIG. 2) of the hardcopy medical documents 75. Once the one or more electronic copies 75′ of the hardcopy medical documents 75 have been prepared, the provider 14 may return the hardcopy medical documents 75 to the subscriber 12 or one or more authorized persons 18. In another implementation, for increased security, in order to prevent unauthorized access to the subscriber's hardcopy medical records, the provider 14 may destroy (e.g., shred) the hardcopy medical records after the quality control and indexing step (see, e.g., step 118 in FIG. 2) is complete.

As the medical information 75 is received by the provider 14, the software or a data entry person at a computer workstation 14′ may review and electronically catalog (the information that is received by entering the one or more documents received, the type (e.g., paper, digital image, video, SMS, etc.) of document, the subscriber's name (e.g., first and last name), the date and time the document was received, the number of pages in the document and the like. All of the one or more documents received at the conversion center may subsequently be electronically indexed by attaching, for example, metadata, which can include document type, subscriber name and the date the document was created, to the received medical information 75. If hardcopy medical documents 75 (i.e., documents in non-digital form) are received at the provider 14, the hardcopy medical documents 75 are converted to a digital format prior to electronic cataloging and electronic indexing.

Once: 1) the electronic indexing has been completed, 2) metadata has been linked to the electronic image(s), and 3) quality control including the verification and review of the metadata, document skew of digital image(s), cropping of digital image(s), legibility of digital image(s) and digital image quality have been confirmed by the quality control staff that the one or more electronic, private medical records 50 has passed the quality review checks, the documents are then stored (e.g., locally on-site, and/or remotely at, e.g., the mainframe hosting center 14b) and the index data and digitized information from the submitted hardcopy medical document 75 is encrypted and sent via secure file transfer protocol (FTP) to the mainframe hosting center 14b. At the mainframe hosting center 14b, the software decrypts the index and image data then locates a file associated with the plan selected by the subscriber 12 in order to save any new or modified data entries therein. If the transfer of the data is associated with a “new” subscriber 12 that is sending data to the provider 14 for the first time, the provider 14 creates a new directory using, for example, primary database fields (e.g., full name, date-of-birth, sex and the like) for identifying the new subscriber 12. The index data and other information (e.g., digital image information) is then encrypted and stored on the mainframe hosting center 14b. In an implementation, the index data and the other information may be backed up at one or more of the local and remote hosting facility 14b, 14c on a periodic (e.g., daily) basis. The subscriber 12 and the one or more authorized persons 18 may then access the electronic, private medical record 50 at any time from their computer workstation 12′, 18′ by way of, for example, provider's webpage/web portal.

Referring to FIG. 2, an electronic data capture process for preparing an electronic, private medical record 50 is shown generally at 100 according to an embodiment. In an implementation, the subscriber 12 sends 102 medical information 75 in their possession to the provider 14. In an example, the subscriber 12 at the subscriber end 10_{S} may send 102 one or more medical information hardcopies 75 from the subscriber end 10_{S} via a mail carrier 20 (e.g., U.S. Postal Service) to the provider 14 at the provider end 10_{P}. The carrier 20 may then transport 104 the medical information 75 to a document conditioning center; the document conditioning center may be the entity 14d associated with the provider 14. In addition to the subscriber 12 sending 102 the medical information 75, the subscriber 12 at the subscriber end 10_{S} may also request that the one or more authorized persons 18 at the one or more authorized persons end 10_{A} send medical information 75 to the document conditioning center 14d.

In an implementation, each hardcopy medical document 75 that is received at the document conditioning center 14d may be catalogued 106. In another implementation, each hardcopy medical document 75 may be barcoded 108. In an embodiment, the barcode that is disposed upon each hardcopy medical document 75 may be scanned in order to generate location data; the location data may be subsequently recalled in order to assist in, for example, determining who was the last known person to be in possession of the hardcopy medical document 75 and/or the last known physical location (e.g., an office number) of each hardcopy medical document 75 such that a chain of possession or location each hardcopy medical document 75 is easily determined as a result of the medical document 75 undergoing a variety of processing steps within the document conditioning center 14d. One of the processing steps may include, for example, removing staples, paperclips or the like for physically separating 110 more than one hardcopy medical document 75 that are joined together.

After completing one or more of steps 106-110, the one or more hardcopy medical documents 75 may be scanned 112 in order to create one or more electronic copies 75′ of the one or more hardcopy medical documents 75. Upon creating the one or more electronic copies 75′ of the one or more hardcopy medical documents 75 as a result of the scanning step 112, the one or more electronic copies 75′ may then be sent 114′ to the content management server 14a that may then subsequently distribute 116 digital data (e.g., the one or more electronic copies 75′) for further processing 118.

As discussed above, in an embodiment, one or more authorized persons 18 at the one or more authorized persons end 10_{A} may contribute to the creation and/or collaborative editing of the electronic, private medical record 50. In an implementation, the one or more authorized persons 18 may, for example, send 114″ medical documents 75′ that are already in electronic form (e.g., imaging studies, SMS messages, MMS messages and the like, noting that SMS and MMS messages may contain a unique number identifying the one or more authorized persons 18 that sent the information, and, therefore, may result in the skipping of a portion of the indexing step) for receipt at the content management server 14a; accordingly the one or more electronic copies 75′ provided by the one or more authorized persons 18 may not have to undergo the cataloguing 106, barcoding 108, separating 110 and scanning 112 steps; if, however, the one or more authorized persons sends hardcopy medical documents 75, the hardcopy medical documents 75 from the one or more authorized persons 18 may have to undergo one or more of the steps 106, 108, 110, 112. Once the one or more electronic copies 75′ from the one or more authorized persons 18 are received by the content management server 14a, the content management server 14a may then subsequently distribute 116 digital data (e.g., the one or more electronic copies 75′) for further processing 118.

The further processing step 118 may include a quality control step 118′ that is conducted by quality control personnel at the document conditioning center 14d. The further processing step 118 conducted by the quality control personnel may include the step of the quality control personnel reviewing 118′ each electronic copy 75′ associated with each hardcopy medical document 75 in order to determine if all of the index data is associated with each electronic copy 75′ is present prior to releasing each electronic copy 75′ to an FTP server 14a′. In another implementation, all of the digital data associated with the one or more electronic copies 75′ that is provided to the content management server 14a is reviewed 118′ by quality control personnel and then indexed 118″ according to, for example, document type. In another implementation, each of the hardcopy medical documents 75 that were previously scanned 112 are then converted 118′, if not done so earlier, by the quality control personnel into to searchable PDF documents prior to indexing 118″ the one or more electronic copies 75′. Once the one or more electronic copies 75′ have been indexed 118″, the one or more electronic copies 75′ are compiled into an electronic, private medical record 50 that is then transferred to the secure FTP server 14a′ where the electronic, private medical record 50 is encrypted and then subsequently sent to one or more of the hosting centers 14b, 14c (e.g., in an implementation, all information may be sent to the primary hosting center where the information is securely stored, and, every evening, the data from the primary hosting facility is synchronized with the backup hosting facility in order to duplicate the records so that the records are stored at both locations).

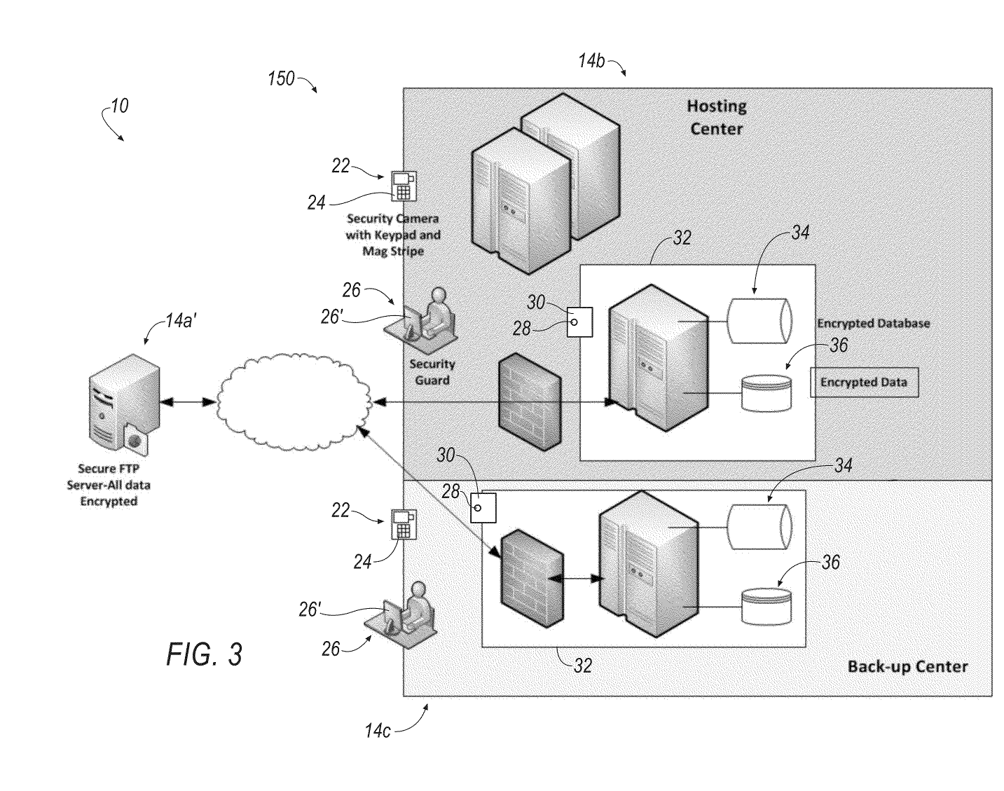

Referring to FIG. 3, the hosting system 10 may include an electronic, private medical record security system 150. The security system 150 may employ physical security measures and electronic (data) security measures for securing the electronic, private medical record 50 and/or the one or more electronic copies 75′ of the hardcopy medical documents 75. As a result of this “double layer” of security (e.g., physical security and digital security), the hosting system 10 is Health Insurance Portability and Accountability Act (HIPPA) compliant.

Firstly, as described above, all data (e.g., the one or more electronic copies 75′ forming the electronic, private medical record 50) is encrypted at the secure FTP server 14a′, which may be subsequently decrypted at the hosting backup center 14b, 14c (i.e., in this scenario, it is unlikely that any information intercepted during the transmission from the FTP server 14a′ to one or more of the hosting centers 14b, 14c would yield unintelligible information). Further, physical security at the hosting backup center 14b, 14c may include, for example, security cameras 22 with keypads 24 and an authorized magnetic key card slot (not shown) formed by the keypads 24 in order to gain access to the physical structure associated with the hosting backup center 14b, 14c. The above results in a redundant physical security feature that significantly reduces a probability that any unauthorized individual will gain physical access to the hosting backup center 14b, 14c.

Once entry to the hosting backup center 14b, 14c is gained, one or more security guards 26 may physically challenge an individual entering the facility (e.g., after the individual enters a security code on the keypad 24, the one or more guards 26 may obtain a pre-recorder facial image (from, e.g., a security guard computer workstation 26′) of an individual associated with the entered code and subsequently compare the pre-recorded image with that of a security camera 22 captured image of, for example the face of the individual that entered the security code on the keypad 24. Although the one or more security guards 26 may perform the physical challenge step, the security system 150 may alternatively employ an automated, computer program that will electronically compare the security camera-generated facial image with the pre-recorded facial image; if the computer program concludes that the facial images do not match, the computer program may send a signal that physically locks-out or prevents the individual from further accessing any area of the hosting backup center 14b, 14c.

After passing the facial comparison challenge step, the individual may be granted further access to the hosting backup center 14b, 14c. The security guard 26, may, for example, provide the individual with access to the hosting backup center 14b, 14c by overriding the access code controls of the keypad 24; in an embodiment, the security guard 26 may not have access to nor grant subsequent physical access by unlocking, for example, a lock 28 that locks shut a door 30 of a cage 32 that contains hardware of the hosting system 10; the locked cage 32 may be separate from the rest of the one or more hosting centers 14b, 14c and may contain, for example, all primary data for the subscriber 12. At the one or more hosting centers, 14b, 14c, database information 34 and image data 36 are both encrypted such that the information 34 and data 36 is “double encrypted;” in the event of a data breach, not only would the database information 34 be unusable and unreadable but all image data 36 would be unusable and unreadable as well. If the one or more hosting centers 14b, 14c is/are a local hosting backup center 14b, all of the data stored therein is synchronized and replicated to a remote backup center 14c on a periodic (e.g., daily) basis.

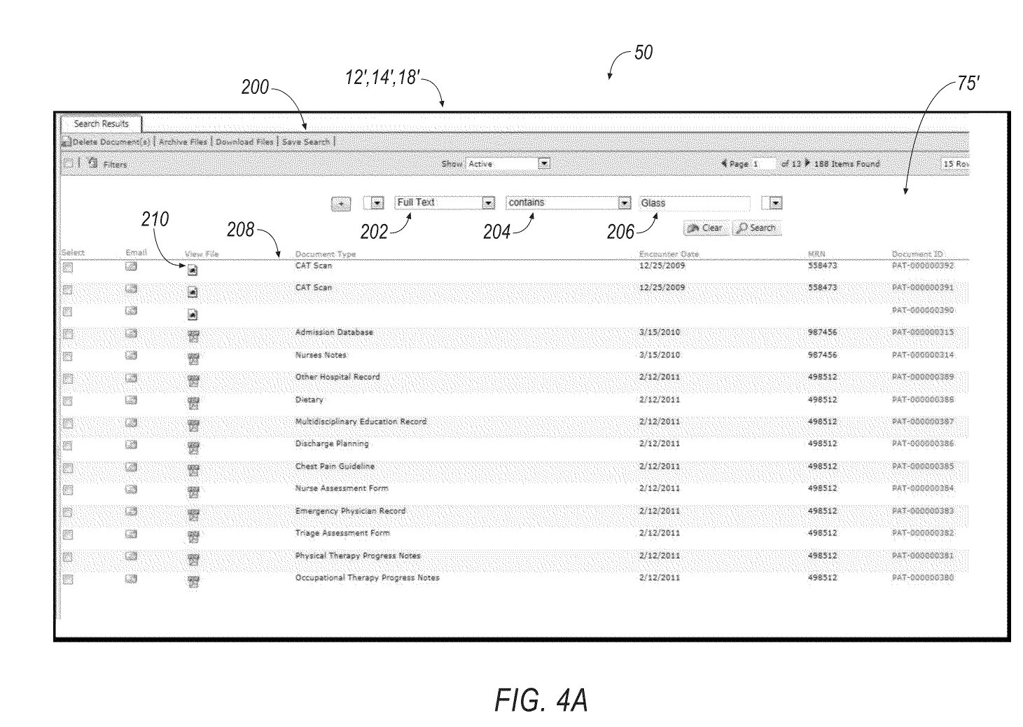

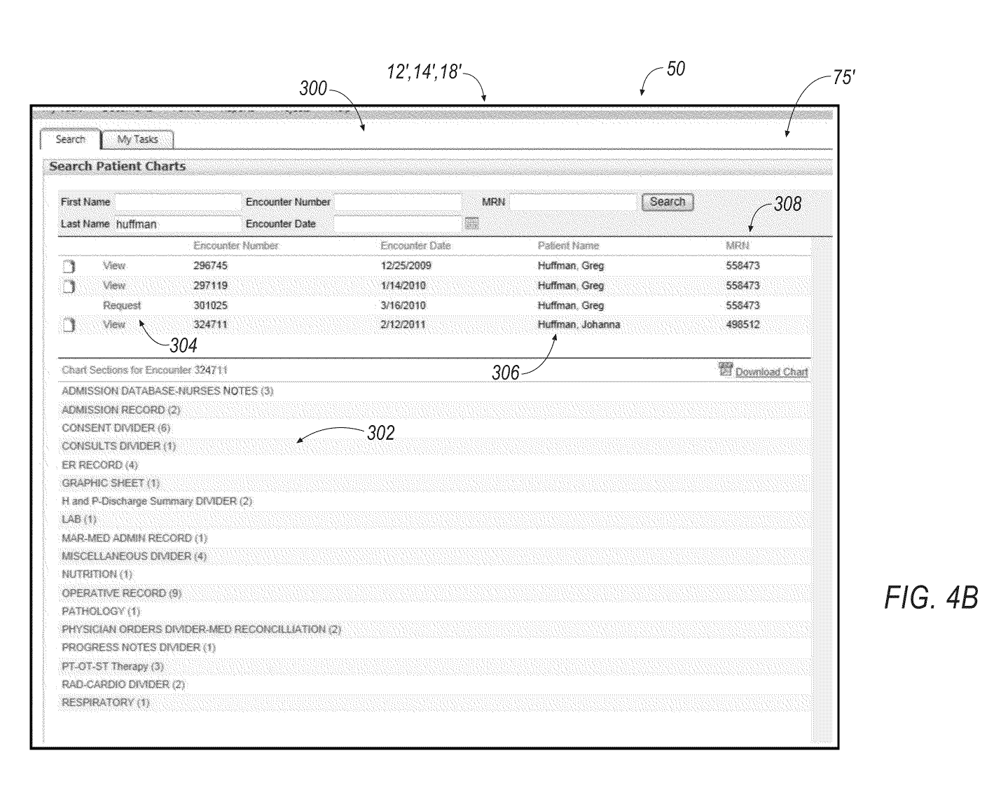

Referring to FIG. 4A, one attribute of the hosting system 10 is the organization and retrieval of the electronic medical information 75′ that resides in each electronic, private medical record 50. Rather than relying on the subscriber 12 to think up a schema for organizing their electronic medical information 75′ or insisting that subscribers 12 use a file folder paradigm, the hosting system 10 offers, for example, key word searching or phrase searching capabilities and/or document type retrieval.

An example of a screenshot 200 of an electronic, private medical record 50 is shown in FIG. 4A, which illustrates use of full text retrieval of the electronic, private medical record 50; the screenshot 200 may be displayed upon, for example, any of the computer workstations 12′, 14′, 18′, which may include at least, for example, a monitor display. The screenshot 200 may be an aspect of a computer program that is stored upon, for example, one or more hardware components 14a-14c of the provider 14.

In an implementation, the subscriber 12 may access and manipulate data associated with the electronic, private medical record 50 by way of access to the screenshot 200. The screenshot 200 may be associated with, for example, a web page of a website that is provided by the provider 14. In an implementation, manipulation of the data that is displayed upon/represented by the screenshot 200 may be conducted with one or more of a mouse (not shown), keyboard (not shown) or a voice-control microphone (not shown) of any of the computer workstations 12′, 14′, 18′.

In an implementation, the subscriber 12 may access and manipulate the data related to the electronic, private medical record 50, as follows. The subscriber 12 may firstly select a full text option of retrieval of information 202 and then subsequently select a Boolean operator 204 (e.g., “contains,” “within,” “not,” etc.) in order to specify a keyword or phrase 206 that the subscriber 12 believes may be included in the electronic, private medical record 50. Upon striking, for example, an “Enter” key (not shown) on the keyboard of the computer workstation 12′, a list of one or more documents 208 may be presented to the subscriber 12. The presentation of the one or more documents 208 may be in reverse chronological order or chronological order and may also indicate, for example, document type and date that the document was created. If the subscriber 12 wishes to view one of the one or more documents 208, the subscriber 12 may utilize, for example, the mouse by “double-clicking” on an image icon 210; a full-page image of the selected document may then be presented along with thumbnails of subsequent pages within the selected document. If the selected document is, for example, a video, the video may start playing upon the subscriber 12 “double-clicking” on the video icon 210.

In another example, a subscriber 12 may be aware of a specific document that is included in their electronic, private medical record 50, and, therefore, may know of a specific document that he or she is looking for (e.g., a list of their prescriptions, vaccination history, or the like). Accordingly, in an embodiment, when searching for documents when the index type is known, another document retrieval option, as seen in a screenshot 300 (see FIG. 4B), may be made available to the subscriber 12. In an example, the screenshot 300 may be presented upon conducting an index search with the keyword being, for example, the subscriber's last name; after depressing the “Enter” key, the subscriber 12 may be presented with a screen listing of different document types associated with, for example, the subscriber's family members 302. The screenshot 300 may also indicate 304 if any of the displayed documents have been reviewed, printed or viewed and whose record was presented 306. The screenshot 300 may also display a unique identifier 308 assigned during the conversion process for each electronic medical information document 75′ that was catalogued in the electronic, private medical record 50. The subscriber 12 may also have the option of either looking at specific document types or reviewing the entire electronic, private medical record 50.

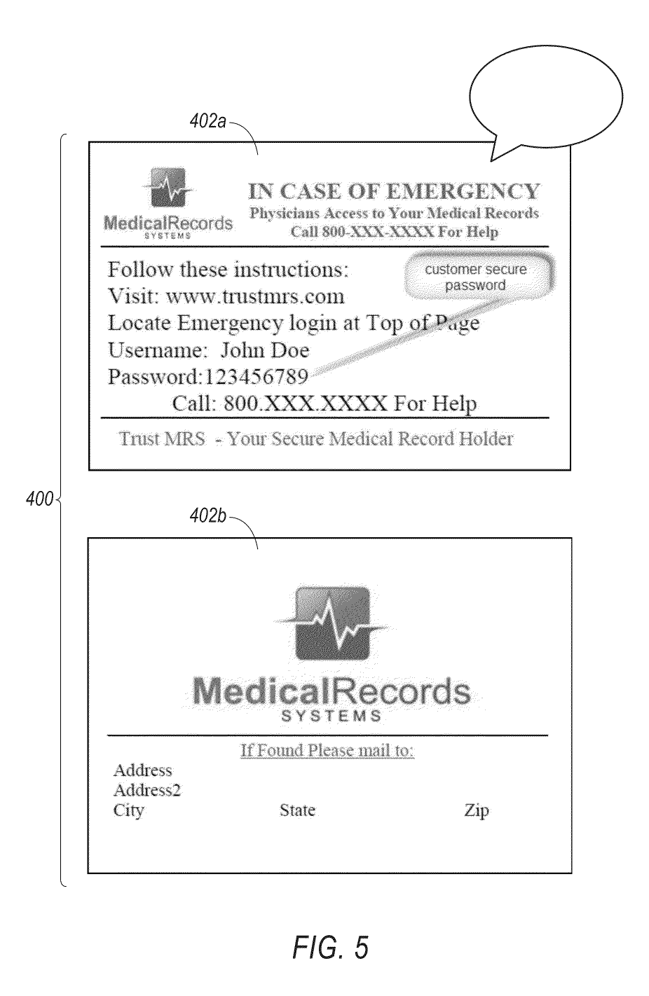

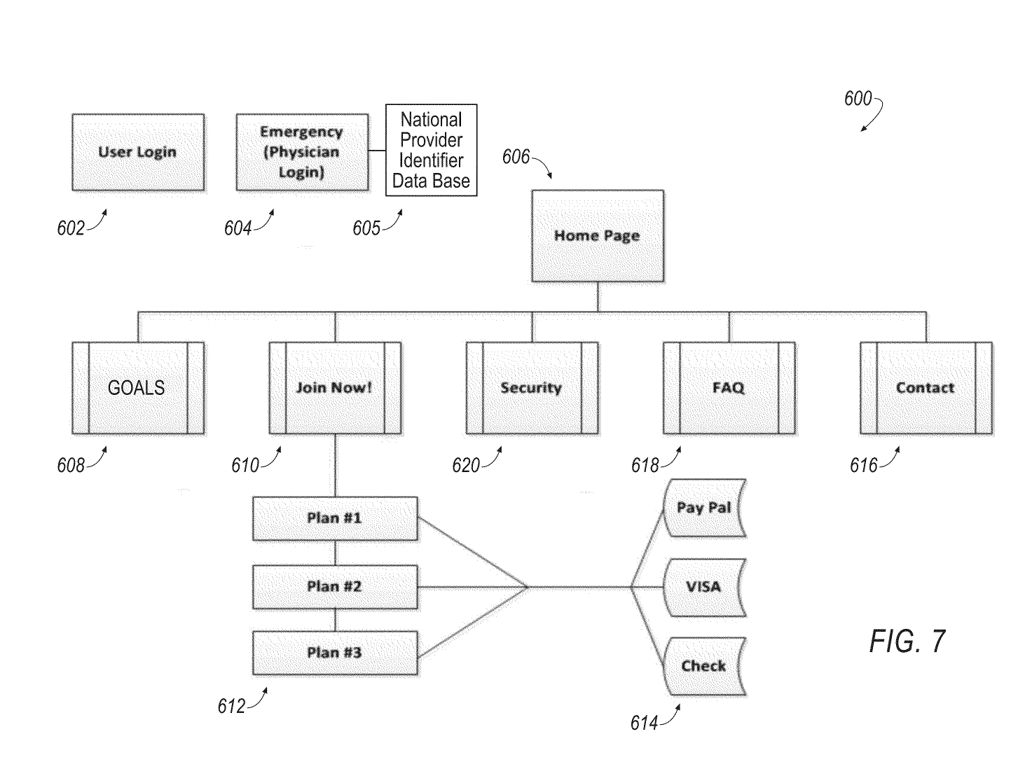

Referring to FIG. 5, in another embodiment, the provider 14 may also issue an emergency medical card 400 to the subscriber 12. The emergency medical cart 400 may include a front surface 402a and a rear surface 402b. The emergency medical card 400 may be carried upon the subscriber's person and may identify the subscriber/owner of the electronic, private medical record 50 stored upon the hosting system 10. If the subscriber 12 is unable to independently seek medical attention, emergency response staff may locate the emergency medical card 400 upon the subscriber's person and obtain a password and telephone number therefrom in order to gain access to the subscriber's electronic, private medical record 50. In an example, in order to validate that the person attempting to obtain access to the electronic, private medical record 50 is actually a physician who needs access to the record 50, the physician may be asked for their National Physician Identification (NPI) number (see 605 in FIG. 7); the NPI number may then be compared to the national registry that is updated on a monthly basis for the Center for Medicine and Medicaid Services in order to determine if a valid physician is trying to gain access to the subscriber's medical records. If a valid NPI number is entered, and, if, for example, the IP address is in the same city/state where access to the record 50 is requested, the system 10 may grant access to the record 50 from the requesting physician; however, if for example, the NPI number and the IP address does not correspond, the system 10 may deny access to the requesting party (i.e., the system 10 is assuming that the requesting party is not the physician associated with the entered NPI number and that the requesting party is an identify thief).

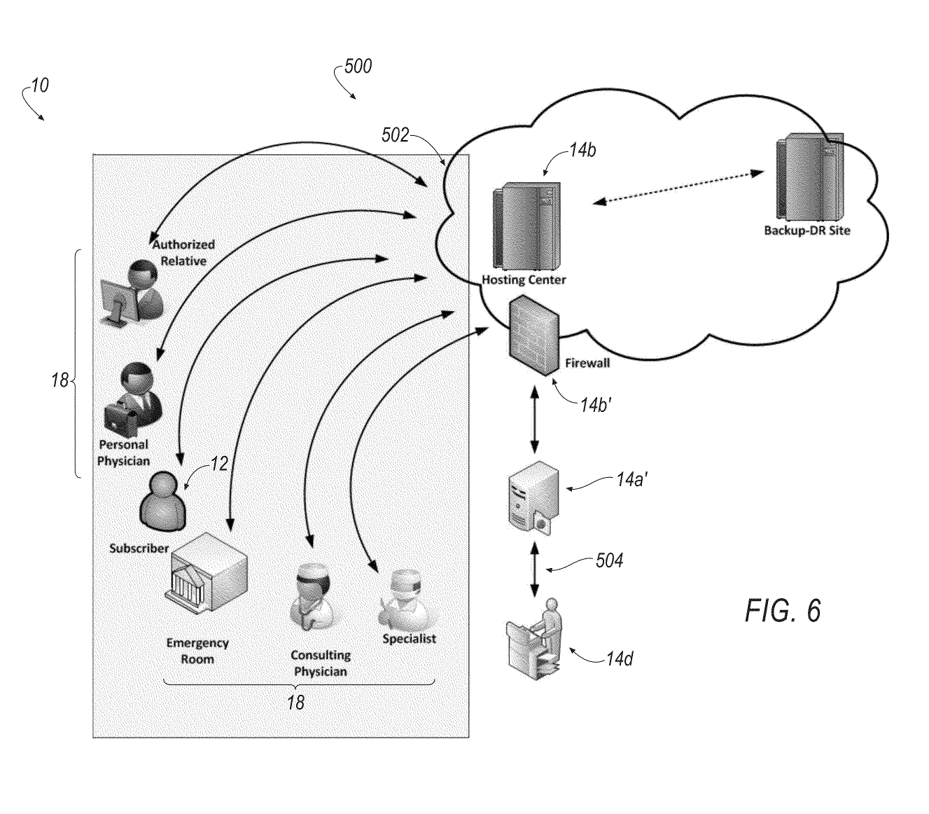

Referring to FIG. 6, a schematic illustrating access to the hosting system 10 is shown at 500. In an implementation, as described above, the electronic, private medical record 50 may be created, controlled, organized and indexed by professional staff in the document conditioning center 14d. Retrieval of medical information contained in the electronic, private medical record 50 may be conducted by the subscriber 12 and the one or more authorized persons 18, such as, for example: a primary care physician 18, an authorized family member 18, a consulting specialist 18 or an emergency room physician 18. Retrieval of the medical information in the electronic, private medical record 50 is provided via, for example, a website portal 502. With the sensitivity of the electronic medical information 75′ being collected and stored on behalf of the subscriber 12, secure transfer 504 and import at the mainframe hosting center 14b is enforced. Although the secure FTP process, which is point-to-point, and, therefore, almost impossible to intercept or to displace, the hosting system 10 may enforce common import security measures in the configuration of firewalls 14b′ of the mainframe hosting center 14b.

Referring to FIG. 7, a wireframe 600 of an exemplary website associated with the hosting system 10 is shown according to an embodiment. The hosting system 10 may permit subscriber access 602 or emergency access 604 to the subscriber's electronic, private medical record 50 by way of the website 600; accordingly, the website 600 may employ different security and access measures to the electronic, private medical record 50 in view of the person(s) requesting access to the electronic, private medical record 50. For example, login by way of emergency access 604 may be visible on the homepage 606 of website 600 whereas subscriber access 602 may utilize a username and password after selecting/“clicking on” a “sign-in” image from, for example, a drop-down menu on the website's home page 606. In an example, a physician may obtain the emergency medical card 400 from (e.g., an unconscious) subscriber 12 requiring medical attention in order to permit the physician to login 604 to the system 10. Before proceeding further, the physician may be asked 605 to enter his/her NPI number; in an embodiment, the entered NPI number may be associated with a residency area (e.g., home region/home physical location) and compared to the residency area (e.g., physical location) of the IP address of the requesting party (e.g., in the present example, the physician). If the entered number is determined to be valid (e.g., the home region of the physician matches the physical location of the IP address), the physician may be granted access to the system 10. In another embodiment, the physician may be asked to enter both of the NPI number and a zip code of their last registered work facility; this information may be utilized alone or in combination with the physical location of the IP address in order to verify that the person requesting access to the system is the physician and not an identify thief. Alternatively or in addition to the above information, the system 10 may ask the physician to enter one or more of the subscriber's first name, last name, date of birth and password from the emergency medical card 400. Other pages on the website 600 include an overview of the subscriber's health goals 608 (e.g., weight loss, cholesterol level, blood pressure, etc.) such that the website 600 may be visually adapted/tailored to a specific subscriber's health needs; it will be appreciated, however, that while an embodiment of the system 10 may provide many functions beyond indexing, organizing and securely storing health related documents for subscribers 12, the system 10 may also be designed for including a calendar for medical appointments, health exercise goals, diet program and the like.

For subscribers 12 that decide to access a join page 610 for subscribing to the hosting system 10 for personal medical record management, the hosting system 10 may offer a plurality (e.g., three) different plans 612 related to individual or group needs. In an embodiment, a first plan may be designed for individuals and couples. In another embodiment, a second plan may be designed for small families. In another embodiment, a third plan may be designed for larger families of, for example, five or more members. After selecting a plan 612, the subscriber 12 may be asked to authorize a method of payment by accessing a payment page 614; the payment mode may include, for example, a check, credit card, PAYPAL®, or the like. The subscriber 12 may then access a “contact us” page 616 in order to locate the provider's contact information (e.g., e-mail address, telephone number, etc.) in order to answer any question that is not addressed upon, for example, a frequently asked question (FAQ) page 618 of the website 600. Each page may contain security information 620 in order to avoid hijacking of the website 600 and to ensure sustainability of any accessed information therefrom.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method, comprising the steps of:
arranging an electronic medical record hosting system including a provider end and one or more of a subscriber end and an authorized person end;
providing medical information from one or more of the subscriber end and the authorized person end to the provider end;
electronically storing the provided medical information at the provider end;
utilizing a computer workstation at any of the provider end, the subscriber end and the authorized person end for permitting any of the provider end, the subscriber end and the authorized person end to securely electronically view and/or securely electronically modify the medical information that is electronically stored at the provider end.

2. The method according to claim 1, further comprising the step of:
cataloging the medical information.

3. The method according to claim 1, further comprising the step of:
barcoding the medical information.

4. The method according to claim 1, wherein the providing medical information includes
providing electronic medical information from one or more of the subscriber end and the authorized person end to the provider end.

5. The method according to claim 1, wherein the providing medical information includes
providing hardcopy medical information from one or more of the subscriber end and the authorized person end to the provider end.

6. The method according to claim 5, further comprising the step of:
creating an electronic copy of the hardcopy medical information at the provider end.

7. The method according to claim 6, wherein the creating step includes scanning the hardcopy medical information at the provider end.

8. The method according to claim 5, wherein the hardcopy medical information includes more than one hardcopy document joined together, wherein the method further includes the step of:
physically separating the more than one hardcopy document joined together at the provider end.

9. The method according to claim 1, wherein the providing medical information step includes one or more of medical information that is convertible from hardcopy form to digital form and medical information already in digital form.

10. The method according to claim 9, wherein the electronically storing step further includes the step of:
sending the medical information in digital form to a content management server.

11. The method according to claim 10, further comprising the steps of:
distributing the medical information in digital form to a quality control center at the provider end for:
reviewing the medical information in digital form to determine if index data is present,
indexing the medical information in digital form, and
compiling the medical information in digital form into an electronic, private medical record.

12. The method according to claim 11, further comprising the steps of:
releasing the electronic, private medical record from the quality control center at the provider end to an FTP server where the electronic, private medical record is encrypted, and
sending the encrypted, electronic, private medical record to one or more of a hosting center and a hosting backup center.

13. A medical record system, comprising:
a provider end that compiles the medical information in digital form into an electronic, private medical record;
an FTP server that that receives and subsequently encrypts the electronic, private medical record; and
an electronic, private medical record security system including:
one or more digital storage devices for digitally storing the electronic, private medical record, and
at least one physical security device and at least one structural security devices for physically securing the one or more digital storage devices.

14. The medical record system according to claim 13, wherein the at least one physical security device includes:
at least one security camera,
at least one keypad, and
at least one magnetic key card slot formed in the keypad.

15. The medical record system according to claim 13, wherein the at least one physical security device includes:
a cage that encapsulates the one or more digital storage devices,
a door attached to the cage, that, when in an open orientation, permits physical access to the one or more digital storage devices, or, when in a closed orientation, denies physical access to the one or more digital storage devices, and
a lock attached to the door and the cage, that, when in the unlocked orientation, permits the door to be arranged in the open orientation, or, when in a locked orientation, denies arrangement of the door in the open orientation but rather retains the door in the closed orientation.

16. A computer program product encoded on a computer readable storage medium comprising instructions that when executed by a data processing apparatus cause the data processing apparatus to perform operations comprising:
electronically storing provided medical information at a provider end; and
permitting any of the provider end, a subscriber end and an authorized person end to securely electronically view and/or securely electronically modify the medical information that is electronically stored at the provider end.

17. The computer program product according to claim 16, wherein the operations further comprise the step of:
cataloging the medical information.

18. The computer program product according to claim 16, wherein the operations further comprise the step of:
barcoding the medical information.

19. The computer program product according to claim 16, wherein the providing medical information step includes
providing electronic medical information from one or more of the subscriber end and the authorized person end to the provider end.

20. The computer program product according to claim 16, wherein the providing medical information step includes
providing hardcopy medical information from one or more of the subscriber end and the authorized person end to the provider end.

21. The computer program product according to claim 20, wherein the operations further comprise the step of:
creating an electronic copy of the hardcopy medical information at the provider end.

22. The computer program product according to claim 21, wherein the creating step includes scanning the hardcopy medical information at the provider end.

23. The computer program product according to claim 16, wherein the providing medical information step includes one or more of medical information that is convertible from hardcopy form to digital form and medical information already in digital form.

24. The computer program product according to claim 23, wherein the electronically storing step further includes the step of:
sending the medical information in digital form to a content management server.

25. The computer program product according to claim 24, further comprising the steps of:
distributing the medical information in digital form to a quality control center at the provider end for:
reviewing the medical information in digital form to determine if index data is present,
indexing the medical information in digital form, and
compiling the medical information in digital form into an electronic, private medical record.

26. The computer program product according to claim 25, further comprising the steps of:
releasing the electronic, private medical record from the quality control center at the provider end to an FTP server where the electronic, private medical record is encrypted, and
sending the encrypted, electronic, private medical record to one or more of a hosting center and a hosting backup center.
